(19) United States
(12) Patent Application Publication
(10) Pub. No.: US 2015/0126210 A1
(43) Pub. Date: May 7, 2015

(54) INTERFERENCE-AVOIDANCE ORIENTED CARRIER REUSE OF DEVICE-TO-DEVICE (D2D) COMMUNICATION IN CELLULAR NETWORKS

(71) Applicant: Nokia Corporation, Espoo (FI)

(72) Inventors: Tao Peng, Beijing (CN); Yuan Qi, Beijing (CN); Ziyang Liu, Beijing (CN); Kodo Shu, Shanghai (CN); Jianchi Zhu, Beijing (CN)

(73) Assignee: NOKIA CORPORATION, Espoo (FI)

(21) Appl. No.: 14/404,778

(22) PCT Filed: Jun. 4, 2012
(86) PCT No.: PCT/CN2012/076438

§ 371 Date: Dec. 1, 2014

(51) Int. Cl. H04W 72/08

(52) U.S. Cl. CPC H04W 72/082
USPC 455/452.1

(57) ABSTRACT

An apparatus and method for interference-avoidance in a hybrid communications network is provided. The method includes obtaining related information for interfering cellular user equipment in the hybrid network, reporting the related information for the interfering cellular user equipment to an evolved Node B (eNB), receiving a list of component carriers and competition related information for the component carriers, and selecting one or more proper component carriers from the list of component carriers according to certain rules.

### BACKGROUND

1. Field

Embodiments of the invention generally relate to wireless communications networks, such as, but not limited to, the Universal Mobile Telecommunications System (UMTS) Terrestrial Radio Access Network (UTRAN) and/or Long Term Evolution (LTE) Evolved UTRAN (E-UTRAN) or LTE-Advanced (LTE-A), and to device-to-device (D2D) links that enable direct communication of data between user equipment.

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (Evolved UTRAN) no RNC exists and most of the RNC functionalities are contained in the evolved Node B (eNB).

Long Term Evolution (LTE) or E-UTRAN refers to enhancements of the UMTS through improved efficiency and services, lower costs, and use of new spectrum opportunities. In particular, LTE is a 3GPP technical standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplex (FDD) and Time Division Duplex (TDD).

As mentioned above, LTE is also expected to improve spectral efficiency in 3G networks, allowing carriers to provide more data and voice services over a given bandwidth. Therefore, LTE is designed to fulfill future needs for high-speed data and media transport in addition to high-capacity voice support. Advantages of LTE are, for example, high throughput, low latency, FDD and TDD support in the same platform, an improved end-user experience, and a simple architecture resulting in low operating costs.

Further releases of 3GPP LTE (e.g., Rel-10, Rel-11) are targeted towards future international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

### SUMMARY

One embodiment is directed to a method including obtaining, in a hybrid device-to-device (D2D) and cellular network, related information for interfering cellular user equipment. The method may further include reporting the related information for the interfering cellular user equipment to an evolved node B (eNB), receiving a list of component carriers and competition related information for the component carriers, and selecting at least one proper component carrier from the list of component carriers according to certain rules.

Another embodiment includes an apparatus which may include at least one processor and at least one memory comprising computer program code. The at least one memory and the computer program code may be configured, with the at least one processor, to cause the apparatus at least to obtain, in a hybrid device-to-device (D2D) and cellular network, related information for interfering cellular user equipment, to report the related information for the interfering cellular user equipment to an evolved node B (eNB), to receive a list of component carriers and competition related information for the component carriers, and to select at least one proper component carrier from the list of component carriers according to certain rules.

Another embodiment may include a computer program, embodied on a computer readable medium. The computer program may be configured to control a processor to perform a process including obtaining, in a hybrid device-to-device (D2D) and cellular network, related information for interfering cellular user equipment. The process may further include reporting the related information for the interfering cellular user equipment to an evolved node B (eNB), receiving a list of component carriers and competition related information for the component carriers, and selecting at least one proper component carrier from the list of component carriers according to certain rules.

Another embodiment may include an apparatus comprising means for obtaining, in a hybrid device-to-device (D2D) and cellular network, related information for interfering cellular user equipment. The apparatus may further include means for reporting the related information for the interfering cellular user equipment to an evolved node B (eNB), means for receiving a list of component carriers and competition related information for the component carriers, and means for selecting at least one proper component carrier from the list of component carriers according to certain rules.

Another embodiment is directed to a method including receiving, from a device-to-device (D2D) user equipment, related information for interfering cellular user equipment in a hybrid network. The method may further include determining, by an evolved node B (eNB), reusable component carriers for the D2D user equipment to utilize, and sending a list of the reusable component carriers and competition related information for the reusable component carriers to the D2D user equipment.

Another embodiment includes an apparatus which may include at least one processor and at least one memory comprising computer program code. The at least one memory and the computer program code may be configured, with the at least one processor, to cause the apparatus at least to receive, from a device-to-device (D2D) user equipment, related information for interfering cellular user equipment in a hybrid network, to determine re-usable component carriers for the D2D user equipment to utilize, and to send a list of the reusable component carriers and competition related information for the reusable component carriers to the D2D user equipment.

Another embodiment may include a computer program, embodied on a computer readable medium. The computer program may be configured to control a processor to perform a process including receiving, from a device-to-device (D2D) user equipment, related information for interfering cellular user equipment in a hybrid network. The process may further include determining reusable component carriers for the D2D user equipment to utilize, and sending a list of the reusable component carriers and competition related information for the reusable component carriers to the D2D user equipment.

Another embodiment may include an apparatus comprising means for receiving, from a device-to-device (D2D) user equipment, related information for interfering cellular user equipment in a hybrid network. The apparatus may further include means for determining reusable component carriers for the D2D user equipment to utilize, and means for sending a list of the reusable component carriers and competition related information for the reusable component carriers to the D2D user equipment.

### BRIEF DESCRIPTION OF THE DRAWINGS

For proper understanding of the invention, reference should be made to the accompanying drawings, wherein:

FIG. 1 illustrates a system according to one embodiment of the invention;

FIG. 2 illustrates a signaling diagram according an embodiment;

FIG. 3 illustrates a system according to another embodiment;

FIG. 4 illustrates an example table for obtaining the proper CCs for uplink of cellular UEs, according to an embodiment;

FIG. 5 illustrates an apparatus according to one embodiment;

FIG. 6 illustrates an example of a flow diagram for a method, according to one embodiment; and

FIG. 7 illustrates an example of a flow diagram for a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of a system, a method, an apparatus, and a computer program product for interference-avoidance, as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

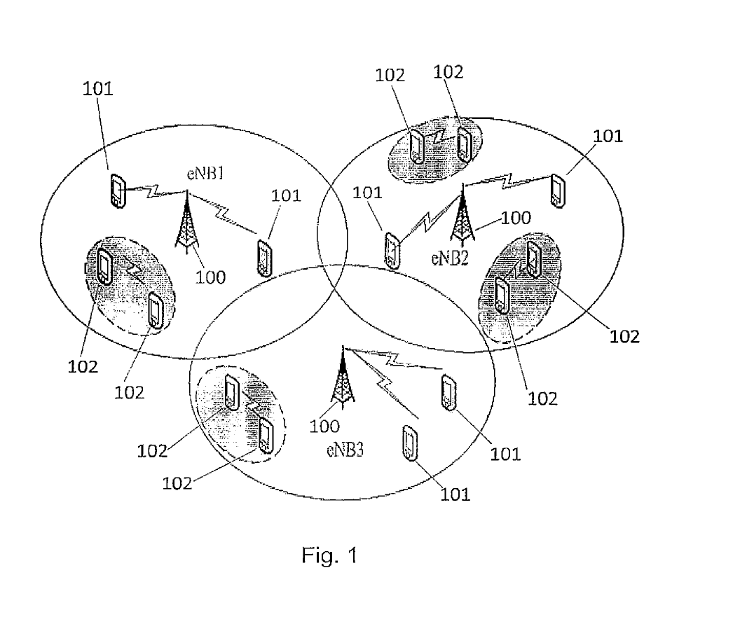

Embodiments of the invention relate to the hybrid or mixed device-to-device (D2D) and LTE-Advanced (LTE-A) cellular networks. A hybrid communication network involving LTE-A cellular and D2D may be deployed, for example, in order to achieve better throughput. FIG. 1 illustrates an example of a hybrid communication system, according to one embodiment. In the mixed scenario depicted in FIG. 1, user equipment (UE) 101 can operate in dual communication modes: cellular communication mode and D2D communication mode.

In the cellular communication mode, UE 101 communicates with another cellular UE 101 through an eNB 100. In the D2D communication mode, however, D2D UE 102 communicates directly to another D2D UE 102 without any central control. The cellular communication mode can provide the benefit of easy control of resource utilization and interference since there is a centralized controller, such as the eNB 100. However, this mode may lead to inefficient resource utilization. Flexibility of resource utilization is an advantage of D2D communication, but it is difficult for autonomous D2D UEs 102 to obtain complete resource allocation information. Therefore, in the hybrid network, the critical problems are mainly from resource allocation and interference situation.

Finding the proper resources to reuse is one of the key issues when D2D UEs 102 reuse cellular UEs' 101 resources in a hybrid D2D and cellular network. In principle, D2D UEs 102 can reuse cellular resources which are not being used by the cellular UEs 101 temporarily or in a certain geographical area. Among all the reusable resources, some relatively static/semi-static resources are usually appropriate choices for D2D UEs 102 to reuse. The “static/semi-static” denotes that the resources are not used by cellular UEs 101 in a relatively long period for a certain geographical area. The advantages of reuse of such resources include: 1) If the reusable resource is static/semi-static, D2D UEs 102 do not need to determine when and where and how long the resource can be reused and do not need to monitor the change of resource situation frequently. Thus, it is quite possible that reusing this type of resource could be less costly in time and effort for D2D UEs 102; 2) the “static/semi-static” resource means that cellular UEs 101 may not return during a relatively long period. Because D2D UEs 102 do not know the distance between cellular UEs 101 and themselves, and are blind to the accumulated interference suffered by cellular UEs 101, reuse of such resources may bring fewer risks to impose interference between D2D and cellular communication.

In LTE-A systems, carrier aggregation (CA) is employed to provide larger bandwidth to enhance data rate. The eNB does not assign all its component carriers (CCs) to each UE 101. For cellular UEs 101, CCs can be divided into three categories: activated CCs, configured but non-activated CCs, and non-configured CCs. Once a CC is configured to UE, it will be used with high probability. Those configured CCs can be activated/de-activated by medium access control (MAC) layer signaling. In addition, the CCs not being configured can be called non-configured CCs. The configuration and activation/deactivation of CCs are carried out semi-statically. Therefore, the non-configured CCs and configured but non-activated CCs are proper resources for D2D UEs 102 to reuse because little interference could be imposed on cellular and D2D communication since these CCs are not allocated to cellular UEs 101 and are semi-static scheduled.

An efficient carrier reuse approach should tackle the interference problem and keep signaling overhead low. In LTE-A, the non-configured and configured but non-activated CCs can be exploited to handle this problem. Embodiments of the invention provide a feasible solution for proper carrier reuse in the mixed D2D and cellular network scenario, as will be discussed in detail below.

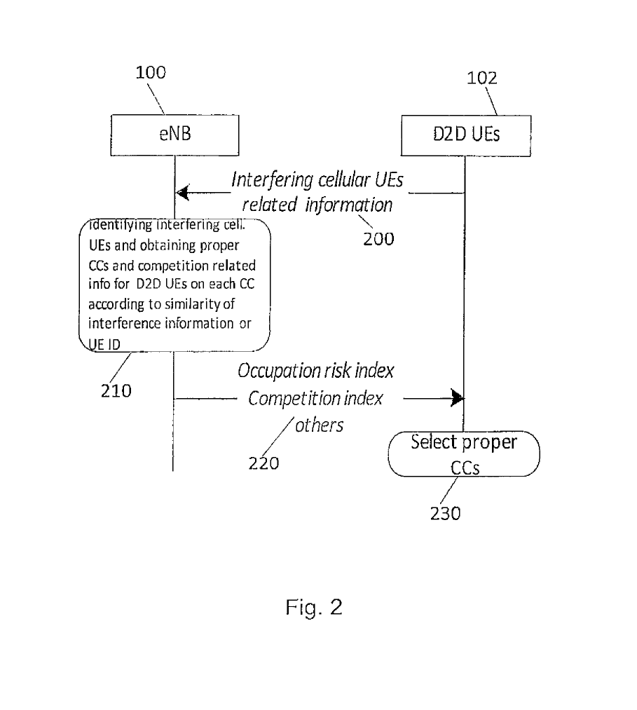

FIG. 2 illustrates a signaling diagram depicting how a D2D UE 102 selects a proper CC according to the information of reusable CCs, according to one embodiment. In this embodiment, it is assumed that D2D UE 102 is able to communicate with eNB 100. According to one embodiment, the D2D UE 102 obtains the interfering cellular UEs 101 related information before reusing any non-configured or configured but non-activated CCs. The related information may include the kind of interference information, e.g. CC index, SINR, the interfering cellular UE identifier (ID), etc. As illustrated in FIG. 2, at 200, the procedure may include, after the D2D UE 102 obtains the related information of the interfering cellular UEs 101, reporting the related information to the eNB 100 and awaiting further information about reusable CCs.

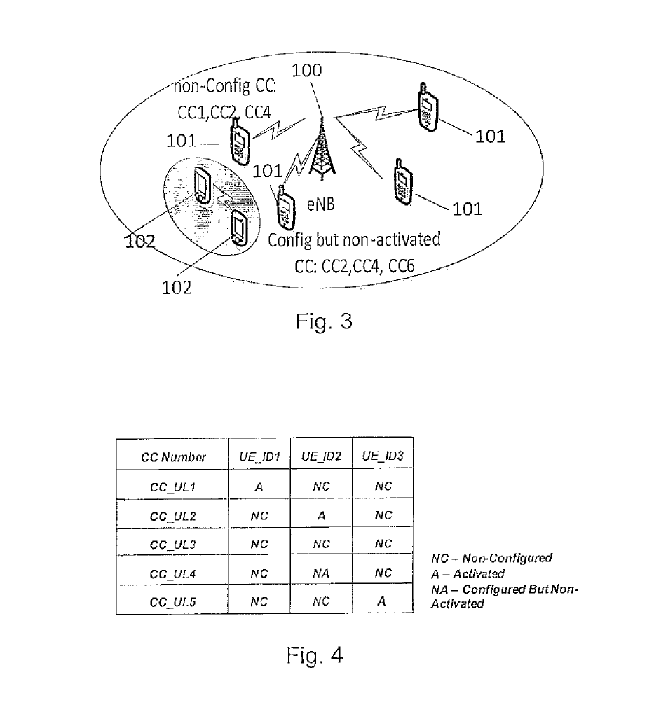

In one embodiment, the eNB 100 obtains the proper reusable CCs for the D2D UEs by performing, for example, a comparison of the configured and activated CCs of interfering UEs with all CCs the eNB 100 has. According to an embodiment, at 210, the eNB 100 identifies interfering cellular UEs and obtains proper CCs and competition related information for D2D UEs on each CC according to the similarity of interference information, such as CC index, SINR or the UE identifier (ID). As a result, the eNB 100 can obtain the proper reusable CCs for the D2D UE 102 to utilize. As illustrated in FIG. 3, in some embodiments, the proper reusable CCs for the D2D UEs 102 may include non-configured or configured but non-activated CCs of cellular UEs 101 nearby or around the D2D UE 102. Additionally, in some embodiments, the proper reusable CCs for the D2D UEs 102 may include configured but non-activated CCs.

FIG. 4 illustrates an example for obtaining the proper CCs for uplink of cellular UEs, according to an embodiment. In the example illustrated in FIG. 4, the eNB has five CCs. It should be noted that the number of CCs is not limited to five, as any number of CCs may be available. In FIG. 4, “NC” denotes non-configured CCs, “A” denotes activated CCs, and “NA” denotes configured but non-activated CCs. In the example of FIG. 4, the interfering cellular UEs are UE_ID1, UE_ID2, and UE_ID3. For uplink, CC_UL1 is activated for UE_ID1, CC_UL2 is activated for UE_ID2, CC_UL4 is configured but not activated for UE_ID2, and CC_UL5 is activated for UE_ID3, as illustrated in FIG. 4. Thus, in this example, CC_UL3 is reusable for D2D UEs since it is not configured for the interfering cellular UEs. It is noted that CC configuration for the cellular UEs can be relatively semi-static such that the reusable CCs may stay stable for a while.

Returning to FIG. 2, at 220, the eNB 100 sends the list of proper CCs to D2D UE 102 after processing. The CC list may contain non-configured as well as configured but non-activated CCs. The CC list may further include competition related information, such as occupation risk index and competition index, if available.

The Occupation risk index is a parameter to indicate the risk of a situation change of the non-configured/configured but non-activated CC (be occupied by cellular UEs) according to the scheduling. Since the CC is semi-static configured to a cellular UE, the eNB 100 can evaluate this index according to rules through how long the non-configured and/or configured but non-activated CC is scheduled for other cellular UEs which are not around the D2D UEs 102. In some embodiments, the occupation risk index provides reference information indirectly about how long the CC can be reused by D2D UEs 102 rather than the exact duration. This is because that the eNB 100 does not control the resource allocation. The eNB 100 can also obtain this occupation risk index according to service requirement, buffer status, configuration information, etc. of cellular UEs.

The Competition index relates to when resource sharing between D2D UEs 102 is competition-based. In particular, if the resource sharing between D2D UEs 102 is competition-based, the eNB 100 is able to estimate the number of candidate D2D UEs 102 on each CC and convert it to the collision risk indicator. If the reported interference information, e.g. CC index, SINR or UE ID are similar among several D2D UEs 102, this means these D2D pairs are close to each other and that they may launch competition on the same resources. The more D2D UEs 102 gather together, the greater the risk of conflict. Thus, in one embodiment, the competition index is a parameter that estimates this risk of conflict or competition for resources. So the eNB 100 can distribute these messages to the D2D UE 102 and assist the D2D UEs to reduce the collision probability. In one embodiment, there are at least two ways to use the competition index: (1) If the D2D resource allocation is controlled by the eNB 100, it can schedule D2D UEs 102 over different CCs by signaling; (2) If the D2D resource allocation is totally competition-based, the D2D pairs can choose proper CCs accordingly, at least in part, to the competition index.

Table 3 illustrates an example format for the list of reusable CCs. However, embodiments of the invention are not limited to the format shown in Table 3, as other formats are possible.

TABLE 3

| CC | | Occupation | Competition |
|---|---|---|---|
| number | type | risk index | index |
| CC_UL3 | Non-configured | T1 | C1 |
| CC_UL4 | Configured but Non-Activated | T2 | C2 |
| CC_DL3 | Non-configured | T3 | C3 |

In the example of Table 3, T1-T3 stand for the occupation risk, which can be a predicted time after which the cellular users will be allocated on the present CC. C1-C3 indicate how many D2D UEs 102 may use the present CC to launch transmission, which can be a quantified value of competition level predefined by the protocol or the D2D UEs' number. It should be noted that the occupation risk index is not a timer, as it is not an exact value of time duration for D2D UEs 102 to reuse the CC since the eNB 100 does not schedule the resource of D2D UEs 102. Rather, in one embodiment, the occupation risk index is a predicted time duration after which the cellular UEs 101 will be allocated on the present CC and, thus, indicates the risk that the CC will be occupied by a cellular UE 101. In an embodiment, the occupation risk index can serve as reference information for D2D UEs 102 when they decide how long the CC can be used.

According to some embodiments, the two indices, the occupation risk index and the competition index, can be used as follows:
The D2D UE 102 gets the indices from the eNB 100 and prepares to launch transmission.
According to the D2D transmission data quantity and target rate, the D2D pair is able to estimate the transmission time. Then, it can pick out suitable CCs from the list and sorts all suitable CCs according to the index values. It considers choosing the CC with the smallest value of the indices from the candidate CC set for less collision risk with other D2D pairs. The D2D pair will try CCs in the candidate set one by one based on the sort until the transmission is successful.

Returning to FIG. 2, at 230, the D2D UE 102 selects a proper CC to reuse. For example, after receiving the information of reusable CCs from the eNB 100, the D2D UE 102 can determine proper CCs through competition. In one embodiment, the D2D UE 102 can select a proper CC to reuse from the list according to certain rules. For instance, the following rules may be applied by the D2D UE 102 in the resource reusing:
The non-configured CCs have priority to the configured but non-activated CCs for D2D UE 102 to reuse.
The CCs with less collision risk are more preferred.
The CCs with smaller occupation risk index are more suitable for continuous transmission and CCs with larger occupation risk index are more suitable for opportunity transmission.
The D2D UE 102 combines both indices (occupation risk index and competition index) into consideration.
Any other applicable rules

In an embodiment, before the D2D UE 102 reuses the selected CC, it may carry out a measurement on that CC to verify the reusable carrier. For instance, the D2D UE 102 may measure the received power on that CC. If the received power is lower than a certain threshold as shown below in equation (1), it will confirm that the carrier can be reused. This measurement, however, is optional.

P_{RX}≦λ (1)

where P_{RX} is the received signal strength and denotes the threshold, which can be predefined in protocols or sent to the D2D UE from the eNB.

According to some embodiments, the D2D UE 102 can set up a predicted time duration after which the cellular UEs 101 will be allocated on the present CC and reuse the proper CC according to its occupation risk index. If the predicated time duration is terminated, the D2D UE 102 could turn to step 230 to determine whether it can continue to reuse the CC through measurement or signaling.

In certain embodiments, the D2D communication is autonomous with the network's assistance. In this way, the D2D UE 102 selects the proper resources after it obtains the reusable CC list and competition related information rather than eNB's 100 allocation. This approach is suitable for reusing cellular UE's carriers of uplink.

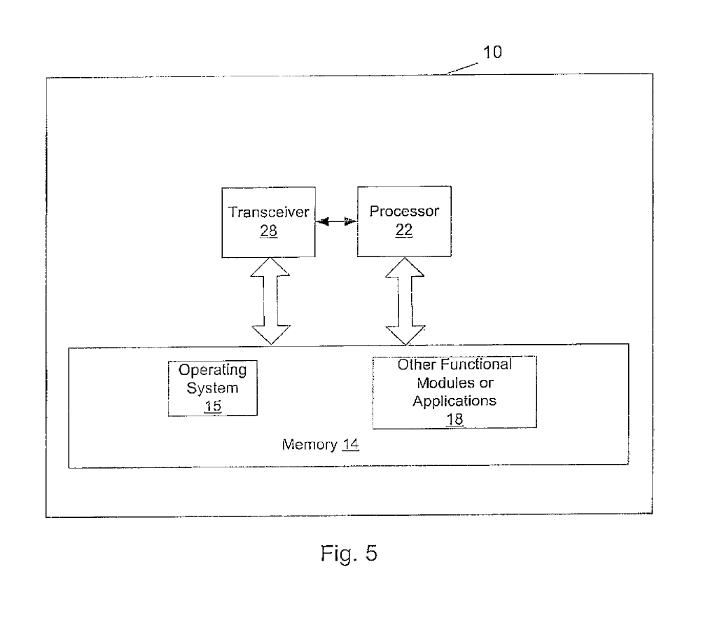

FIG. 5 illustrates an apparatus 10 configured for interference-avoidance in a hybrid communication network, according to an embodiment. In one embodiment, apparatus 10 may be an eNB, as illustrated in FIGS. 1-3 discussed above. In other embodiments, apparatus 10 may be a UE, such as a D2D UE illustrated in FIGS. 1-3 above.

It should be noted that FIG. 5 does not necessarily illustrate all components of apparatus 10. Only those components necessary for understanding embodiments of the invention are illustrated, but one of ordinary skill in the art would understand that apparatus 10 may include additional components that are not illustrated.

Apparatus 10 includes a processor 22 for processing information and executing instructions or operations. Processor 22 may be any type of general or specific purpose processor. While a single processor 22 is shown in FIG. 5, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable medium. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

As mentioned above, in one embodiment, apparatus 10 may be a UE, such as a D2D UE operating in a hybrid D2D and cellular network. In this embodiment, apparatus 10 is controlled by memory 14 and processor 22 to obtain related information for interfering cellular UE(s) in the hybrid network. The related information for the interfering cellular UEs may include, for example, the kind of interference information, e.g. CC index, SINR and/or the ID(s) of the interfering cellular UE(s).

Apparatus 10 may then be controlled by memory 14 and processor 22 to report, via transceiver 28, the related information for the interfering UE(s) to an eNB. Apparatus 10 can then be controlled by memory 14 and processor 22 to receive, via transceiver 28, a list of CCs and competition related information for the CCs from the eNB. In one embodiment, the competition related information may include an occupation risk index and competition index, as discussed above. The list of CCs received from the eNB may include non-configured CCs and/or configured but non-activated CCs.

Apparatus 10 may be further controlled by memory 14 and processor 22 to select one or more proper CCs from the list of CCs based on certain rules. Examples of the rules that may be taken into consideration by the apparatus 10 in selecting the proper CCs include, but are not limited to, the following: non-configured CCs have priority to configured but non-activated CCs for the apparatus 10 to reuse; the CCs with less collision risk are more preferred; the CCs with smaller occupation risk index are more suitable for continuous transmission and CCs with larger occupation risk index are more suitable for opportunity transmission; and the apparatus 10 combines both the occupation risk index and the competition index into its consideration.

In another embodiment, apparatus 10 may be an eNB in in a hybrid D2D and cellular network. In this embodiment, apparatus 10 is controlled by memory 14 and processor 22 to receive, from a D2D UE, related information for interfering cellular UE(s) in the hybrid network. The related information for the interfering cellular UEs may include, for example, the kind of interference information, e.g. CC index, SINR and/or the ID(s) of the interfering cellular UE(s).

Apparatus 10 may then be controlled by memory 14 and processor 22 to determine reusable CCs for the D2D UE to utilize by, for example, comparing configured and activated CCs of the interfering UEs with all CCs the apparatus 10 has available. Apparatus 10 may be further controlled by memory 14 and processor 22 to transmit, via transceiver 28, a list of the reusable CCs and competition related information for the CCs to the D2D UE. In one embodiment, the competition related information may include the occupation risk index and the competition index, and the list of CCs may include non-configured CCs and/or configured but non-activated CCs.

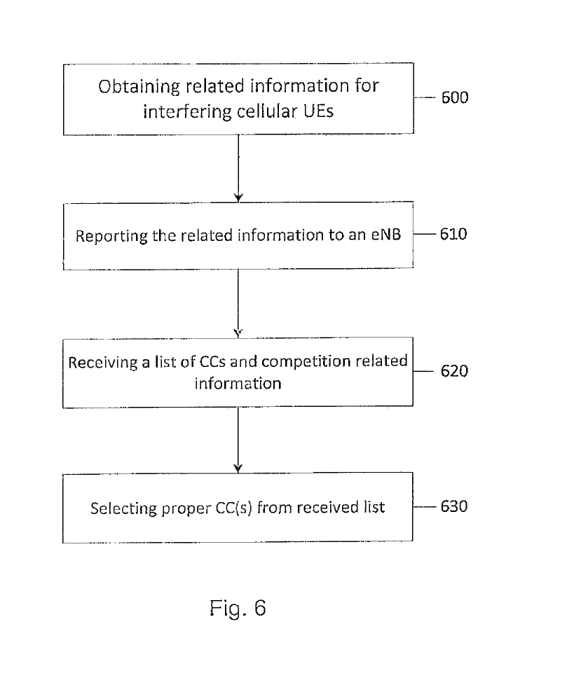

FIG. 6 illustrates an example of a flow diagram of a method, according to one embodiment of the invention. The method includes, at 600, obtaining related information for interfering cellular UE(s) in the hybrid network. At 610, the method includes reporting the related information for the interfering UE(s) to an eNB. The method may then include, at 620, receiving a list of CCs and competition related information for the CCs from the eNB. At 630, the method may include select one or more proper CCs from the list of CCs according to certain rules.

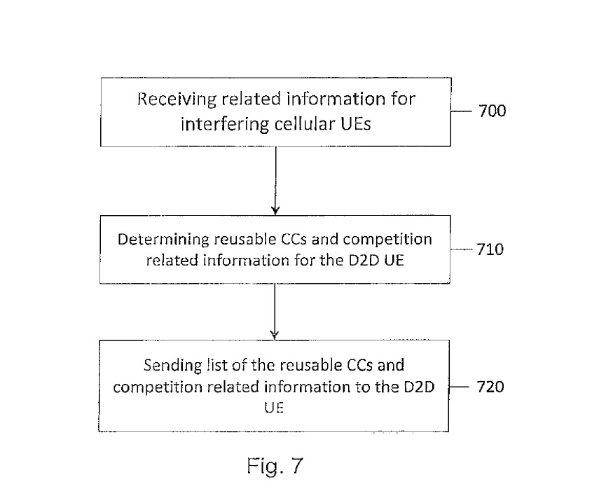

FIG. 7 illustrates an example of a flow diagram of a method, according to another embodiment. The method includes, at 700, receiving, from a D2D UE, related information for interfering cellular UE(s) in the hybrid network. At 710, the method may include determining reusable CCs and competition related information for the D2D UE to utilize. In one embodiment, the determining of the reusable CCs includes comparing configured and activated CCs of the interfering UEs with all CCs the apparatus 10 has available. The method may further include, at 720, sending a list of the reusable CCs and competition related information for the CCs to the D2D UE.

In some embodiments, the functionality of any of the methods described herein, such as the method of FIGS. 6 and 7, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

Embodiments of the invention provide a system, apparatus, and/or method to identify proper carriers including non-configured and configured but non-activated CCs which can be reused for D2D communication. Several distinct advantages are provided according to certain embodiments. For example, some advantages include achieving efficient resource reuse since the non-configured and configured but non-activated carriers are not left unused. Additionally, no matter when and where D2D UEs reuse these CCs, little interference would be imposed on cellular and D2D communication since the CCs are semi-static scheduled. Embodiments, therefore, result in an improved user experience.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-32. (canceled)

33. An apparatus, comprising:
at least one processor; and
at least one memory including computer program code,
the at least one memory and the computer program code configured, with the at least one processor, to cause the apparatus at least to
obtain, in a hybrid device-to-device (D2D) and cellular network, related information for interfering cellular user equipment;
report the related information for the interfering cellular user equipment to an evolved node B (eNB);
receive a list of component carriers and competition related information for the component carriers; and
select at least one proper component carrier from the list of component carriers according to certain rules.

34. The apparatus according to claim 33, wherein the competition related information comprises an occupation risk index and a competition index.

35. The apparatus according to claim 34, wherein the occupation risk index comprises a parameter to indicate a risk of a situation change of the component carriers.

36. The apparatus according to claim 34, wherein the competition index comprises a parameter that estimates a competition level for the component carriers.

37. The apparatus according to claim 33, wherein the related information for the interfering cellular user equipment comprises at least one of a kind of interference information and/or identifiers of the interfering cellular user equipment.

38. The apparatus according to claim 33, wherein the list of component carriers comprises at least one of non-configured component carriers and/or configured but non-activated component carriers.

39. The apparatus according to claim 33, wherein the certain rules comprise at least one of: non-configured component carriers have priority over configured but non-activated component carriers for reuse; the component carriers with less collision risk are preferred; the component carriers with smaller occupation risk index are more suitable for continuous transmission and the component carriers with larger occupation risk index are more suitable for opportunity transmission; and combining both the occupation risk index and the competition index when selecting the proper component carrier(s).

40. The apparatus according to claim 33, wherein the apparatus comprises a D2D user equipment.

41. A computer program, embodied on a computer readable medium, the computer program configured to control a processor to perform a process, comprising:
obtaining, in a hybrid device-to-device (D2D) and cellular network, related information for interfering cellular user equipment;
reporting the related information for the interfering cellular user equipment to an evolved node B (eNB);
receiving a list of component carriers and competition related information for the component carriers; and
selecting at least one proper component carrier from the list of component carriers according to certain rules.

42. An apparatus, comprising:
at least one processor; and
at least one memory including computer program code,
the at least one memory and the computer program code configured, with the at least one processor, to cause the apparatus at least to
receive, from a device-to-device (D2D) user equipment, related information for interfering cellular user equipment in a hybrid network;
determine reusable component carriers for the D2D user equipment to utilize; and
send a list of the reusable component carriers and competition related information for the reusable component carriers to the D2D user equipment.

43. The apparatus according to claim 42, wherein the at least one memory and the computer program code are further configured, with the at least one processor, to cause the apparatus at least to determine the reusable component carriers by comparing configured and activated component carriers of the interfering user equipment with all component carriers available at the evolved node B (eNB).

44. The apparatus according to claim 42, wherein the competition related information comprises an occupation risk index and a competition index.

45. The apparatus according to claim 44, wherein the occupation risk index comprises a parameter to indicate a risk of a situation change of the component carriers.

46. The apparatus according to claim 44, wherein the competition index comprises a parameter that estimates a competition level for the component carriers.

47. The apparatus according to claim 42, wherein the related information for the interfering cellular user equipment comprises at least one of a kind of interference information and/or identifiers of the interfering cellular user equipment.

48. The apparatus according to claim 42, wherein the list of component carriers comprises at least one of non-configured component carriers and/or configured but non-activated component carriers.

49. The apparatus according to claim 42, wherein the apparatus comprises an evolved node B (eNB).

50. A computer program, embodied on a computer readable medium, the computer program configured to control a processor to perform a process, comprising:
receiving, from a device-to-device (D2D) user equipment, related information for interfering cellular user equipment in a hybrid network;
determining reusable component carriers for the D2D user equipment to utilize; and
sending a list of the reusable component carriers and competition related information for the reusable component carriers to the D2D user equipment.
